(19) United States
(12) Patent Application Publication
(10) Pub. No.: US 2018/0187060 A1
(43) Pub. Date: Jul. 5, 2018

(54) COMPOSITION FOR WELL DRILLING COMPRISING REACTIVE METAL AND DEGRADABLE RESIN COMPOSITION, MOLDED PRODUCT FOR WELL DRILLING, AND METHOD FOR WELL DRILLING

(71) Applicant: Kureha Corporation, Tokyo (JP)

(72) Inventors: Masayuki OKURA, Tokyo (JP); Takeo TAKAHASHI, Tokyo (JP); Shinya TAKAHASHI, Tokyo (JP); Takuma KOBAYASHI, Tokyo (JP)

(21) Appl. No.: 15/513,529

(22) PCT Filed: Sep. 15, 2015
(86) PCT No.: PCT/JP2015/076149

§ 371 Date: Mar. 22, 2017

(30) Foreign Application Priority Data
Sep. 22, 2014 (JP) 2014-192603

(51) Int. Cl. C09K 8/035; C09K 8/03; C09K 8/80; C09K 8/42; C08G 63/08; C08K 3/08

(52) U.S. Cl. CPC C09K 8/035; C09K 8/032; C09K 8/80; C09K 8/426; E21B 43/267; C08K 3/08; C08G 2230/00; C08K 2003/0812; C08K 2201/018; C08G 63/08

(57) ABSTRACT

Provided are a molded product for well drilling comprising a reactive metal and a degradable resin composition that promotes a degradation reaction of the reactive metal, preferably a degradable resin composition comprising a degradable resin that generates acid upon degradation or a degradable resin composition containing a degradable resin and an inorganic material or an organic material that promotes degradation of the reactive metal; a molded product for well drilling which is a downhole tool or a downhole tool member; and a method for well drilling that uses said molded product for well drilling.

### TECHNICAL FIELD

The present invention relates to a composition for well drilling suitable for a molded product for well drilling such as a downhole tool, for example, for producing hydrocarbon resources such as petroleum or natural gas and recovering hydrocarbon resources; a molded product for well drilling; a method for well drilling; and the like.

### BACKGROUND ART

Hydrocarbon resources such as petroleum or natural gas have come to be produced by excavation through wells (oil wells or gas wells, collectively called “wells”) having a porous and permeable subterranean formation. As energy consumption increases, wells are becoming very deep and diversified, and there are records of drilling to the depths greater than 9000 m. In wells that are continuously excavated, the productive layer is stimulated in order to continuously excavate hydrocarbon resources efficiently from subterranean formations, in which permeability has decreased over time, or subterranean formations in which permeability was insufficient to begin with. Acid treatment and fracturing methods are known as stimulation methods (Patent Document 1). Acid treatment is a method in which the permeability of the productive layer is increased by injecting an acid such as hydrochloric acid or hydrofluoric acid into the productive layer and dissolving the reaction components of bedrock (such as carbonates, clay minerals, and silicates). However, various problems that accompany the use of strong acids have been identified, and increased costs, including various countermeasures, have also been pointed out. Thus, perforation for forming pores and hydraulic fracturing for forming fractures (also referred to as “fracturing”) in the productive layer using fluid pressure have received attention.

Hydraulic fracturing is a method, in which perforations or fractures are generated in the productive layer by fluid pressure such as water pressure (also simply called “hydraulic pressure” hereinafter). Generally, a vertical hole is drilled, and then the vertical hole is subsequently provided with a bend and a horizontal hole is drilled in a subterranean formation several thousand meters underground. Fluid such as fracturing fluid is then fed into these boreholes (meaning holes provided for forming a well, also called “downholes”) at high pressure, and fractures and the like are produced by the hydraulic pressure in the subterranean productive layer (layer that produces the hydrocarbon resource such as petroleum or natural gas), and the productive layer is thereby stimulated so that the hydrocarbon resource are extracted and recovered through the fractures and the like. The efficacy of hydraulic fracturing has also been examined for the development of unconventional resources such as shale oil (oil that matures in shale) and shale gas.

Fractures and the like formed by fluid pressure such as water pressure immediately close due to pressure in the formation when the hydraulic pressure is no longer applied. To prevent a fracture closure, a proppant is included in the fracturing fluid (i.e. the well treatment fluid used in fracturing), which is fed into the borehole at high pressure, thereby distributing the proppant in the fracture. Fracturing fluid sometimes contains a channelant in order to form flow paths through which shale oil, shale gas, and the like can pass among the proppant. Accordingly, in addition to the proppant, various additives are used in well treatment fluid, such as channelants, gelling agents, antiscale agents, acids for dissolving rock and the like, friction-reducing agents, and the like.

Various types of water-based, oil-based, and emulsion-based fluids are used as injection well treatment fluids which are fed in at high pressure, such as fracturing fluid. Because the well treatment fluid is required to have the function of transporting the proppant to the location where the fracture is generated in the borehole, it generally is required to have a prescribed viscosity, good proppant dispersibility, ease of after-treatment, and low environmental load, and water-based well treatment fluids are widely used.

The following method is typically used to produce fractures and perforations by hydraulic pressure in the productive layer of a subterranean formation (layer that produces the hydrocarbon resource such a petroleum such as shale oil or natural gas such as shale gas) using fluid fed in at high pressure. Specifically, a prescribed section of a borehole (downhole) drilled in a subterranean formation several thousand meters deep is partially plugged while temporarily sealing it sequentially from the tip portion of the borehole using a well treatment fluid containing, for example, a plugging agent (also called a temporary plugging agent, lost circulation material, diverting agent, and the like, typically used in the shape of granules), and fluid is fed in at high pressure into the plugged section to produce fractures and perforations in the productive layer. Then, the next prescribed section (typically toward the origin of drilling relative to the preceding section, i.e., a segment closer to the ground surface) is plugged to produce fractures and perforations. Subsequently, this process is repeated until the required temporary plug and formation of fractures and perforations have been completed.

Stimulation of the productive layer is sometimes repeated for desired sections of boreholes that have already been formed, and is not limited to drilling of new wells. In this case as well, the downhole treatment such as plugging, fracturing, and the like are similarly repeated. Additionally, there are also cases where, to perform finishing of the well, the borehole is plugged to block fluid from below, and after finishing of the top portions thereof is performed, the plugging is released. On the interior of these newly formed boreholes or previously formed boreholes, various tools are used to perform required operations, and these tools have the generic name “downhole tools.” In a broad sense, the term downhole tool is used as a concept that includes a drilling device or power source thereof for performing further drilling of a well, as well as sensors and communications devices for acquiring and exchanging tool position or drilling information. The term is also used as a concept that includes downhole tool members such as the plugs and plug members or parts and the like described below.

For example, Patent Document 2 discloses a plug (also called a “frac plug,” “bridge plug,” “packer,” or the like), which is a downhole tool used to plug or fix a borehole. Patent Document 2 discloses a plug for well drilling (also called “downhole plug”), and specifically discloses a plug containing a mandrel (main body) having a hollow part in the axial direction, a ring or annular member along the axial direction on the outer circumferential surface orthogonal to the axial direction of the mandrel, a first conical member and slip, a malleable element formed from elastomer, rubber, or the like, a second conical member and slip, and an anti-rotation feature. Sealing of the borehole by a plug for well drilling is performed as follows. Specifically, by moving the mandrel in the axial direction thereof, as the gap between the ring or annular member and the anti-rotation feature gets smaller, the slip contacts the slanted face of the conical member, and by proceeding along the conical member, it expands radially in the outward direction, contacts the inside wall of the borehole, and is fixed in the borehole to seal the borehole, and also, the malleable element deforms by diametric expansion, contacts the inside wall of the borehole, and seals the borehole. The mandrel has a hollow part in the axial direction, and the borehole can be sealed by setting a ball (also called a “ball sealer”; a ball is also included in the concept of a downhole tool or downhole tool member) therein. Patent Document 2 describes that metal materials (aluminum, steel, stainless steel, and the like), fibers, wood, composite materials, plastics, and the like are widely exemplified as materials that form plugs (materials are also included in the concept of a downhole tool member), and that composite materials containing a reinforcing material such as carbon fibers, especially polymer composite materials of epoxy resin, phenol resin, and the like, are preferred, and that the mandrel is formed from aluminum or a composite material. On the other hand, for balls, Patent Document 2 describes that, in addition to the previously described materials, a material that degrades depending on temperature, pressure, pH (acid, base), and the like may be used.

Plugs, ball sealers, and other downhole tools or downhole tool members used in well drilling (hereinafter also collectively called “downhole tools (members)”) are arranged sequentially inside a borehole until the well is completed, but is required to be removed at the stage when production of petroleum such as shale oil or natural gas such as shale gas (hereinafter collectively called “petroleum or natural gas”) is begun. Because a downhole tool such as a plug is typically not designed to be retrievable after use and release of plugging, it is removed by destruction or by making it into small fragments by milling, drill out, or another method, but substantial cost and time are required for milling, drill out, and the like. There are also plugs specially designed to be retrievable after use (retrievable plugs), but since plugs are placed deep underground, substantial cost and time are required to retrieve all of them. Thus, it has been widely attempted to make improvements aimed at the use of degradable materials as downhole tools.

Patent Document 3 discloses a composition containing a reactive metal, which has high strength and can degrade under certain conditions, and can be used in balls and plugs used in valve operation, as well as in proppants and the like, and in oil field elements used in fracturing, acid treatment, and the like. Patent Document 3 discloses a composite material including a degradable metal and a polymer as the above composition that degrades in whole or in part either immediately or after a controlled and predictable time has elapsed after being exposed to a fluid. As the fluid, aqueous fluids, organic fluids, liquid metals, and the like are mentioned. Additionally, as substances exhibiting an effect similar to controlled release in the pharmaceutical field, coating with a water-soluble polymer is disclosed, and the water-soluble polymer is exemplified by polyvinyl alcohol, polyvinyl butyral, polyvinyl formal, polyacrylamide, polyacrylic acid, and the like. In Patent Document 3, a reactive metal is defined as one that readily bonds with oxygen to form a very stable oxide, one that reacts with water to produce diatomic hydrogen, and/or one that readily absorbs oxygen, hydrogen, nitrogen, or another non-metallic element to become brittle. It is disclosed that such a metal can be selected from calcium, magnesium, and aluminum, and examples of alloying elements include lithium, gallium, indium, zinc, and bismuth.

Additionally, Patent Document 4 discloses a method for removing a corrodible downhole article having a surface layer by corroding it using a corrosive material, the method including a step of eroding the surface coating of a corrosion-resistant metal layer by physical fracturing, chemical etching, or a combination of physical fracturing and chemical etching. In Patent Document 4, water, brine, hydrochloric acid, hydrogen sulfide, and the like are cited as the corrosive material, and as the corrodible downhole article, one consisting of a corrodible core of magnesium alloy or the like and a surface coating of a metal layer having a thickness of not greater than 1000 μm is exemplified, and a ball seat or frac plug is cited.

Due to increased demand for securement of energy resources and environmental protection, particularly as excavation of unconventional resources expands, excavation conditions are becoming increasingly harsh, such as increased depth. Furthermore, excavation conditions are more diversified, e.g. temperature conditions are more diversified from approximately 25° C. to approximately 200° C. in accordance with diversification of depth. Specifically, downhole tools such as balls (ball sealers) or ball seats or plugs such as frac plugs, bridge plugs, or packers need to have various properties, such as mechanical strength (tensile strength, compressive strength, and the like) to allow the material to be transported to a depth of several thousand meters underground; oil resistance, water resistance, and heat resistance such that they maintain mechanical strength and the like even when in contact with the hydrocarbon resource to be recovered in the high-temperature and high-humidity environment of a deep subterranean downhole; and seal performance and mechanical strength such that they can maintain closure even by high water pressure when plugging a downhole for performing perforation or fracturing. Additionally, there is an increased demand that such downhole tools also have the property of being easily removable under the environmental conditions of the well at the stage when the well for hydrocarbon resource recovery has been completed (as described above, there are various environments such as temperature conditions in accordance with diversification of depth). Furthermore, there is also a need for proppants, which is used as supports to prevent disintegration of fractures formed by fracturing, to be degradable and removable under prescribed conditions.

Thus, based on the fact that excavation conditions have become harsh and diverse, there has been a demand for a composition for well drilling, wherein the composition is degradable in certain environments and has excellent strength, and is suitable for forming a molded product for well drilling such as a downhole tool (member) or the like that can reliably perform well treatment under diverse well environment conditions, can be easily removed, and can contribute to reducing the expense and shortening the processes of well drilling.

### PRIOR ART DOCUMENTS

### Patent Literature

Patent Document 1: Japanese Patent Publication “Japanese Unexamined Patent Application Publication (Translation of PCT Application) No. 2003-533619T”

Patent Document 2: US Patent Application Publication No. 2011/0277989A1 Specification

Patent Document 3: US Patent Application Publication No. 2007/0181224A1 Specification

Patent Document 4: US Patent Application Publication No. 2012/0318513A1 Specification

### SUMMARY OF INVENTION

### Technical Problem

An object of the present invention, based on the fact that excavation conditions have become harsh and diverse, is to provide a composition for well drilling, where the composition is degradable in certain environments and has excellent strength, and is suitable for forming a molded product for well drilling such as a downhole tool (member) or the like that can reliably perform well treatment under diverse well environment conditions, can be easily removed, and can contribute to reducing the expense and shortening the processes of well drilling. Another object of the present invention is to provide a molded product for well drilling such as a downhole tool (member) formed from the composition for well drilling, and a method for well drilling using the molded product for well drilling.

### Solution to Problem

As a result of diligent research to solve the above problem, the present inventors discovered that the problem can be solved by a composition for well drilling that forms a molded product for well drilling wherein the composition contains both a reactive metal and a degradable resin composition that promotes degradation of the reactive metal, thereby enabling it to have the required intrinsic strength of the reactive metal and enabling degradation thereof easily and in a desired time by, for example, contacting it with water of a prescribed temperature.

Specifically, according to a first aspect of the present invention, a composition for well drilling containing a reactive metal and a degradable resin composition that promotes degradation of the reactive metal is provided.

According to a second aspect of the present invention, a molded product for well drilling formed from the above composition for well drilling is provided.

Additionally, according to another aspect of the present invention, a well treatment fluid containing the above molded product for well drilling is provided. According to yet another aspect of the present invention, a method for well drilling using the above molded product for well drilling is provided, and furthermore, a method for well drilling including performing well treatment using the above molded product for well drilling, and then degrading and dissipating the reactive metal using the above degradable resin composition, is provided.

### Advantageous Effects of Invention

The present invention exhibits the effect of providing a composition for well drilling that contains a reactive metal and a degradable resin composition promoting degradation of the reactive metal. Such a composition is degradable in certain environments and has excellent strength, and is suitable for forming a molded product for well drilling such as a downhole tool (member) or the like that can reliably perform well treatment, can be easily removed, and can contribute to reducing the expense and shortening the processes of well drilling, as excavation conditions have become harsh and diverse.

Furthermore, the present invention exhibits the effect of providing a molded product for well drilling and a well treatment fluid, wherein the molded product for well drilling such as a downhole tool (member) is formed form the above composition for well drilling. Such a molded product for well drilling and a well treatment fluid can reliably perform well treatment, can be easily removed under diverse well environment conditions, and can contribute to reducing the expense and shortening the processes of well drilling, as excavation conditions have become harsh and diverse.

Furthermore, the present invention exhibits the effect of providing a method for well drilling using the above molded product for well drilling. Such a method can reliably perform well treatment, can be easily removed, and can contribute to reducing the expense and shortening the processes of well drilling, as excavation conditions have become harsh and diverse.

### BRIEF DESCRIPTION OF THE DRAWINGS

FIG. 1 is a schematic cross-sectional view illustrating a specific example of a downhole tool which is a molded product for well drilling formed from the composition for well drilling of the present invention.

### DESCRIPTION OF EMBODIMENTS

### I. Composition for Well Drilling Containing Reactive Metal and Degradable Resin Composition that Promotes Degradation of Reactive Metal

The composition for well drilling of the present invention is a composition for well drilling that is degradable in certain environments and has excellent strength, and is suitable for forming a molded product for well drilling such as a downhole tool (member) or the like that can reliably perform well treatment under diverse well environment conditions, can be easily removed, and can contribute to reducing the expense and shortening the processes of well drilling, as excavation conditions have become harsh and diverse.

### 1. Reactive Metal

The reactive metal contained in the composition for well drilling of the present invention is a metallic element that degrades by readily bonding with oxygen to form a very stable oxide, reacting with water to produce diatomic hydrogen, and/or readily absorbing oxygen, hydrogen, nitrogen, or another non-metallic element to become brittle, as disclosed in the previously presented Patent Document 3. More specifically, a reactive metal means a single metallic element or an alloy having said metallic element as the main component, capable of easily destroying the shape of an initial molded product for well drilling by a degradation reaction based on a chemical change under certain conditions (e.g., conditions such as temperature and pressure, contact with fluids such as aqueous fluids, and the like) in a well environment (hereinafter also called “downhole environment”). The range of reactive metals may be selected as appropriate by a person skilled in the art in accordance with certain conditions of the presumed well environment or the like, but in many cases, the reactive metal is an alkali metal or alkaline earth metal belonging to group I or group II on the periodic table, or aluminum or the like.

From the perspectives of ease of control of degradation in a well environment and strength and handling demanded in a molded product, the reactive metal is preferably one or more types selected from the group consisting of magnesium, aluminum, and calcium. Also, from the above perspectives, the one or more types of reactive metal preferably selected from the group consisting of magnesium, aluminum, and calcium is even more preferably an alloy. The composition of the alloy includes the reactive metal described above as a main component, i.e. typically in an amount of not less than 50 mass %, preferably not less than 60 mass %, and more preferably not less than 70 mass %. As minor components, such an alloy contains one or a plurality of types such as lithium, gallium, indium, zinc, bismuth, tin, copper, and the like, typically in a total of not greater than 50 mass %, preferably not greater than 40 mass %, and more preferably not greater than 30 mass %.

### 2. Degradable Resin Composition that Promotes Degradation of Reactive Metal

The degradable resin composition that promotes degradation of the reactive metal contained in the composition for well drilling of the present invention is a resin composition, i.e., a composition containing a resin (hereinafter also called “polymer”), wherein the resin composition is capable of promoting degradation of the reactive metal contained in the composition for well drilling described above due to the resin composition degrading, i.e., losing its initial composition.

Promotion of the degradation reaction of the reactive metal contained in a composition for well drilling is broadly classified into two mechanisms: (1) by a substance produced by degradation or the like of the resin contained in the resin composition described above, and (2) by a contact between the reactive metal and a blended agent or the like other than the resin contained in the resin composition described above. As a specific example of mechanism (1), the following case may be contemplated: a substance that promotes degradation of the reactive metal, preferably an acid, is produced by degradation of the resin contained in the resin composition, and degradation of the reactive metal is promoted by the substance that promotes degradation of the reactive metal, such as an acid, contacting the reactive metal. As a specific example of mechanism (2), the following case may be contemplated: the resin contained in the resin composition dissipates in a prescribed environment, and degradation of the reactive metal is promoted by means of some or all of a blended agent other than the remaining resin contacting the reactive metal.

### 2-1. Degradable Resin that Generates Acid upon Degradation

Preferred specific examples of a case corresponding to mechanism (1) above may include the degradable resin composition that contains a degradable resin that generates acid upon degradation. Specifically, the resin which is a component that forms the degradable resin composition produces free acids (including acid derivatives having reactivity) due to breakage of all or some of the bonds of the main chain and the like of the resin (polymer) in a prescribed environment, and the produced acid promotes degradation of the reactive metal contained in the composition for well drilling. Specifically, the acid produced from the degradable resin that generates acid upon degradation promotes degradation of the reactive metal because such an acid can contact the reactive metal contained in the composition for well drilling at a close distance and at a high concentration. Furthermore, in general, many reactive metals become strongly alkaline through a degradation reaction, but according to an aspect of the present invention, it is possible to prevent the environment surrounding the molded product, such as a well environment, from becoming alkaline because the produced acid neutralizes the alkali, and furthermore, an effect of promoting degradation of the reactive metal can also be expected.

The degradable resin that generates acid upon degradation, i.e., the degradable resin that produces acid due to breakage of some or all of the bonds of the main chain and the like of the polymer, is not particularly limited, but examples include polyester, polyamide, and the like. From the perspectives of degradation characteristics, ease of controlling degradation, and molding processability of the resin (polymer) in a well environment, aliphatic polyesters are preferred as the degradable resin that generates acid upon degradation. Thus, in the composition for well drilling according to an aspect of the present invention, the degradable resin composition preferably contains an aliphatic polyester.

### Aliphatic Polyester

Examples of the aliphatic polyester preferably contained in the composition for well drilling according to an aspect of the present invention include polyglycolic acid (PGA), polylactic acid (PLA), and poly-ε-caprolactone, which are widely known as degradable resins. From the perspectives described above, the aliphatic polyester is preferably one or more type(s) selected from the group consisting of PGA, PLA, and glycolic acid-lactic acid copolymer (PGLA), and a more preferred aliphatic polyester is PGA.

More preferably, the PGA, which is an aliphatic polyester, encompasses not only homopolymers of glycolic acid, but also copolymers containing not less than 50 mass %, preferably not less than 75 mass %, more preferably not less than 85 mass %, even more preferably not less than 90 mass %, particularly preferably not less than 95 mass %, most preferably not less than 99 mass %, and above all, preferably not less than 99.5 mass %, of glycolic acid repeating units. The PLA encompasses homopolymers of L-lactic acid or D-lactic acid, as well as copolymers containing not less than 50 mass %, preferably not less than 75 mass %, more preferably not less than 85 mass %, and even more preferably not less than 90 mass %, of L-lactic acid or D-lactic acid repeating units, and stereocomplex polylactic acids obtained by mixing a poly-L-lactic acid and a poly-D-lactic acid. As the PGLA, a copolymer in which the ratio (mass ratio) of glycolic acid repeating units to lactic acid repeating units is from 99:1 to 1:99, preferably from 90:10 to 10:90, and more preferably from 80:20 to 20:80, may be used. The melt viscosity (measurement conditions: temperature 270° C., shear rate 122 sec⁻¹) of these aliphatic polyesters is not particularly limited, but from the perspectives of degradability as well as strength and moldability of the molded product, it is typically from 100 to 10000 Pa·s, often from 200 to 5000 Pa·s, and nearly always from 300 to 3000 Pa·s.

The aliphatic polyester preferably contained in the composition for well drilling according to an aspect of the present invention degrades to produce acid which is an acidic substance, e.g., glycolic acid, lactic acid, or oligomers thereof (those classified as acids). Thus, the produced acid such as glycolic acid, or lactic acid promotes degradation of the reactive metal by contacting the reactive metal contained in the composition for well drilling at a close distance and in a high concentration. For example, a magnesium alloy (trade name: IN-Tallic (trade mark)) is not reactive when immersed in deionized water, but when immersed in a 4 mass % glycolic acid aqueous solution, it immediately produces bubbles (H₂ gas) and dissolves, producing sediment. It can be ascertained that a degradation reaction of magnesium alloy is promoted due to the glycolic acid aqueous solution described above, which was initially acidic, changing to alkaline.

If the degradable resin composition that promotes degradation of the reactive metal contained in the composition for well drilling according to an aspect of the present invention is a degradable resin that generates acid upon degradation, preferably an aliphatic polyester and more preferably PGA, PLA, or PGLA, the content ratio of degradable resin that generates acid upon degradation is not particularly limited, but is typically not less than 30 mass %, preferably not less than 50 mass %, and more preferably not less than 70 mass %. The upper limit of content ratio of degradable resin that generates acid upon degradation described above is not particularly limited and may be 100 mass % (that is, the entire amount of the composition described above), but often is it not greater than 99 mass %, and nearly always not greater than 95 mass %.

### 2-2. Degradable Resin and Inorganic Material or Organic Material that Promotes Degradation of Reactive Metal

As a preferred specific example of a case corresponding to mechanism (2) above, the degradable resin composition contains a degradable resin and an inorganic material or an organic material that promotes degradation of the reactive metal. Specifically, by degradation and dissipation of the degradable resin which is the component that forms the degradable resin composition in a prescribed environment (specifically, a well environment or the like in which aqueous fluid is supplied), the inorganic material or organic material that promotes degradation of the reactive metal contained in the degradable resin composition (also referred to as “degradation trigger” hereinafter) can promote degradation of the reactive metal because it is able to contact the reactive metal contained in the composition for well drilling at a close distance and in a high concentration of inorganic material or organic material. Preferred examples of the degradable resin that degrades and dissipates in certain environments include those containing water-soluble resin that can lose its shape by eluting out into, or absorbing water from, a solvent such as water present in the prescribed environment. Alternative preferred examples of such a degradable resin include those containing a degradable rubber that can degrade by contacting, for example, water in the prescribed environment. Note that the “degradable resin that generates acid upon degradation” described above may also be used as the degradable resin in the degradable resin composition containing a degradable resin and a degradation trigger.

### Water-Soluble Resin

Examples of the water-soluble resin preferably used as the degradable resin contained in the degradable resin composition containing a degradable resin and a degradation trigger include polyvinyl alcohol (PVA), polyvinyl butyral, polyvinyl formal, polyacrylamide (optionally N,N-substituted), polyacrylic acid, polymethacrylic acid, and the like, and copolymers of monomers that form these resins, for example, ethylene-vinyl alcohol copolymers (EVOH), and acrylamide-acrylic acid-methacrylic acid interpolymers. From the perspectives such as ease of control of degradability, strength, and ease of handling, the water-soluble resin preferably contains PVA, EVOH, polyacrylic acid, polyacrylamide, or the like, and more preferably contains a polyvinyl alcohol-based polymer (PVA-based polymer) such as PVA or EVOH.

### Polyvinyl Alcohol-Based Polymer

A PVA-based polymer is a polymer containing a vinyl alcohol unit, specifically a polymer obtained by saponifying a polymer containing a vinyl acetate unit. Specifically, vinyl acetate is polymerized, together with another monomer that is copolymerizable with vinyl acetate (e.g., an olefin such as ethylene, or the like) as necessary, in an alcohol solvent such as methanol, and then the acetate group of the vinyl acetate unit in the polymer is substituted with a hydroxyl group using an alkali catalyst in an alcohol solvent, thereby producing a polymer (PVA) or copolymer (EVOH) containing a vinyl alcohol unit.

### Degradable Rubber

The degradable rubber preferably used as the degradable resin contained in the degradable resin composition containing a degradable resin and a degradation trigger may be one containing a degradable rubber used conventionally for forming molded products for well drilling such as downhole tools (members). Furthermore, degradability in the degradable rubber means degradability such as biodegradability or hydrolyzability such that it can be degraded chemically by some method, and also means, for example, ease of disintegration and loss of its shape upon application of a very small mechanical force (disintegrability) on the member containing the degradable rubber, as a result of decrease in the intrinsic strength of the rubber and embrittlement of the resin due to a decrease in the degree of polymerization or the like. Furthermore, when the degradable rubber is used together with the degradable resin that generates acid upon degradation described above, degradation of the degradable rubber is further promoted by the acid produced from the degradable resin that generates acid upon degradation. As the degradable rubber, one type alone may be used, but a mixture of two or more types of degradable rubber may also be used.

### Specific Examples of Degradable Rubber

Examples of the degradable rubber include degradable rubbers containing one or more type(s) selected from the group consisting of urethane rubber, natural rubber, isoprene rubber, ethylene propylene rubber, butyl rubber, styrene rubber, acrylic rubber, aliphatic polyester rubber, chloroprene rubber, polyester-based thermoplastic elastomer, and polyamide-based thermoplastic elastomer. In addition, from the perspective of degradability and disintegrability, preferred examples of the degradable rubber include degradable rubbers containing a rubber having a hydrolyzable functional group (for example, a urethane group, ester group, amide group, carboxyl group, hydroxyl group, silyl group, acid anhydride, acid halide, and the like). Note that “having a functional group” herein means having a functional group as a bond that forms the main chain of the rubber molecule, or, for example, having a functional group as a side chain of the rubber molecule serving as a crosslinking point. A particularly preferred example of the degradable rubber is a urethane rubber, because it is possible to easily control the degradability or disintegrability thereof by adjusting the structure, hardness, and degree of crosslinking of the rubber or by selecting other compounding agents. Particularly preferred degradable rubbers are those containing urethane rubber having a hydrolyzable urethane bond. Similarly, degradable rubbers containing a polyester-based thermoplastic elastomer or a polyamide-based thermoplastic elastomer are also preferred.

### Urethane Rubber

The urethane rubber (also called “urethane elastomer”) particularly preferably used as the degradable rubber is a rubber material having a urethane bond (—NH—CO—O—) in the molecule, and is normally obtained by condensation of an isocyanate compound and a compound having a hydroxyl group. As the isocyanate compound, aromatic (optionally having a plurality of aromatic rings), aliphatic, or alicyclic di-, tri-, or tetra-polyisocyanates or mixtures thereof are used. The compound having a hydroxyl group is broadly classified into polyester-type urethane rubbers having an ester bond in the main chain thereof (also called “ester-type urethane rubbers” hereinafter) and polyether-type urethane rubbers having an ether bond in the main chain thereof (also called “ether-type urethane rubbers” hereinafter). Ester-based urethane rubbers are preferred in many cases because their degradability and disintegrability are easier to control. Urethane rubber is an elastic body having both the elasticity (flexibility) of synthetic rubber and the rigidity (hardness) of plastic. Urethane rubber is generally known to have excellent abrasion resistance, chemical resistance, and oil resistance. Also, the urethane rubber exhibits high mechanical strength, high load tolerance, and high elasticity with high energy absorbency. Depending on the molding method, urethane rubber can be classified into i) kneaded (millable) type, which can be molded by the same processing methods as general rubber; ii) thermoplastic type, which can be molded by the same processing methods as thermoplastic resin, and iii) cast type, which can be molded by thermosetting process methods using liquid starting materials. Any type may be used as the urethane rubber that forms the degradable rubber contained in the degradable resin composition of the present invention.

Inorganic material or organic material that promotes degradation of reactive metal The inorganic material or organic material that promotes degradation (degradation trigger) of the reactive metal contained together with the degradable resin in the degradable resin composition is not particularly limited provided that it is capable of promoting degradation of the reactive metal contained in the downhole tool member containing a reactive metal, but examples include inorganic materials such as inorganic acids such as hydrochloric acid, nitric acid, phosphoric acid, sulfuric acid, boric acid, and hydrofluoric acid; inorganic bases such as sodium hydroxide, potassium hydroxide, and calcium hydroxide; inorganic salts such as sodium chloride and potassium chloride; and organic materials such as organic acids such as citric acid, succinic acid, oxalic acid, glycolic acid, lactic acid, phosphoric acid, formic acid, and acetic acid; organic bases such as aniline, ammonia, pyridine, and amines; and organic salts. The optimal material may be selected from the perspectives of form (solid, liquid, or the like) in the prescribed well environment (e.g., temperature and the like), degradation reaction promoting effect on the reactive metal, degradability in response to an aqueous fluid, and the like of the inorganic material or organic material. In many cases, as the degradation trigger, the inorganic material that promotes degradation of the reactive metal is preferably an inorganic salt from the perspective of degradability, and the inorganic salt more preferably contains either potassium chloride or sodium chloride from the perspectives of reactive metal degradation reaction promoting effect and ease of handling. In regard to the reactive metal degradation reaction promoting effect, for example, a magnesium alloy (trade name: IN-Tallic (trade mark)) immediately produces bubbles (H₂ gas), dissolves and produces sediment when immersed in a 4 mass % sodium chloride aqueous solution. At the same time, it can be ascertained that degradation of magnesium alloy is promoted by the change of the sodium chloride aqueous solution, which was initially acidic, to alkaline.

The content ratio of the degradable resin (as described above, there are water-soluble resin, degradable rubber, and the like, and it may be a degradable resin that generates acid upon degradation) and the degradation trigger, in the case where the degradable resin composition that promotes degradation of the reactive metal contained in the composition for well drilling according to an aspect of the present invention contains a degradable resin and a degradation trigger, is not particularly limited, and the optimal range may be determined in accordance with the type of reactive metal, the combination of water-soluble resin and degradation trigger, and the well environment, but is typically from 90:10 to 10:90, often from 85:15 to 50:50, and nearly always from 80:20 to 60:40 (mass ratio).

### 2-3. Other Additives and/or Other Resins

In addition to the previously described degradable resin that generates acid upon degradation and/or the degradable resin and the inorganic material or organic material (degradation trigger) that promotes degradation of the reactive metal, the degradable resin composition that promotes degradation of the reactive metal contained in the composition for well drilling according to an aspect of the present invention may further contain other additional polymers and other typically used additional additives such as fillers, plasticizers, colorants, UV absorbents, oxidation inhibitors, processing stabilizers, weather-resistance stabilizers, antistatic agents, flame retardants, mold release agents, antifungal agents, preservatives, and the like, as desired and within a range that does not hinder the object of the present invention. The optimal range of content ratio of these other additional polymers and other additional additives may be selected according to the type thereof and the well environment, but in the above degradable resin composition, it is typically from 0 to 80 mass %, and in many cases from 0 to 70 mass %, and depending on the type of other additional additive, from 0 to 10 mass % (0 mass % means that the other additive and/or other resin is not included).

### Filler

For example, the above degradable resin composition may contain a filler from the perspective of providing a downhole tool member having excellent strength. Examples of the filler include inorganic fillers such as talc, clay, calcium carbonate, silica, mica, alumina, titanium oxide, zirconium oxide, boron nitride, aluminum nitride, and glass; and organic fillers such as urea-formalin resin and melamine-formalin resin. Specifically, the degradable resin composition contained in a downhole tool member containing a degradable resin composition may contain a filler, and the filler may contain one or more type(s) of inorganic filler or organic filler. As the form of the filler, a fibrous filler or a particulate filler may be used. Specifically, the filler may contain one or more type(s) of fibrous filler or particulate filler. The content of the filler is not particularly limited, but in the above degradable resin composition, it is typically from 0 to 70 mass %, and preferably from 0 to 50 mass % (0 mass % means that no filler is included).

### Other Additional Polymers

The degradable resin composition described above contained in the composition for well drilling according to an aspect of the present invention, as described above, may also contain other additional polymers from the perspective of improving various properties. Examples of other additional polymers that may be used include general-purpose resins such as polyethylene, polypropylene, ABS resin, and polystyrene. However, as excavation conditions have become harsh and diverse such as increased depth, from the perspective that a molded product for well drilling provided in a downhole tool is not readily damaged even if it contacts or collides with the various members used in well drilling, it is preferred that the other additional polymer includes a polymer that can act as a shock-resistant material. Specific examples include various rubber materials and elastomer materials. More specifically, examples include natural rubbers or synthetic rubbers such as natural rubber, isoprene rubber, ethylene propylene rubber, and polyurethane rubber; and thermoplastic elastomers such as thermoplastic olefin-based elastomers (ethylene-propylene copolymers, ethylene-vinyl acetate copolymers, and the like), thermoplastic polyester elastomers (aromatic polyester-aliphatic polyester block copolymers, polyester-polyether block copolymers, and the like), thermoplastic polyurethane elastomers, styrene-based thermoplastic elastomers such as styrene-butadiene-styrene block copolymers and styrene-ethylene/butylene-styrene block copolymers (SEBS), and acrylic rubber-containing methacrylate resins containing an acrylic rubber of a rubber component phase in a hard component phase of methacrylate-based resin, preferably having a core-shell structure; and the like. The content of the other additional polymers is not particularly limited, but in the degradable resin composition described above, it is typically from 0 to 30 mass %, and preferably from 0 to 15 mass % (0 mass % means that no other polymers are included).

### 3. Composition for Well Drilling

As long as it is a composition used in well drilling applications and contains both a reactive metal and a degradable resin composition that promotes degradation of the reactive metal described above, the composition for well drilling according to an aspect of the present invention containing a reactive metal and a degradable resin composition that promotes degradation of the reactive metal may be selected in consideration of the specific application in well drilling, usage environment, and the like, without particular limitation on its shape as a composition or on the mutual arrangement of the reactive metal and the degradable resin composition within the composition. The content ratio (mass ratio) of the reactive metal and the degradable resin composition that promotes degradation of the reactive metal is typically from 1:99 to 99:1, in many cases from 5:95 to 95:5, and if desired, from 20:80 to 80:20. Furthermore, the shape of the composition for well drilling may be granular, powdered, pellet-formed, or fibrous, or rod-shaped (round rod, square rod, heteromorphic cross section, and the like), tubular, plate-shaped (film-like or sheet-like), spherical, round pillar-shaped, square pillar-shaped, or a desired shape molded using a mold.

Composition for well drilling of which loss rate of mass after immersion for 72 hours in 150° C. water relative to mass before immersion is from 5% to 100% Additionally, from the perspective of reliably exhibiting degradability in various well environments, the present invention provides a composition for well drilling that exhibits characteristic degradation behavior of having a decrease rate of mass after immersion for 72 hours in 150° C. water relative to mass before immersion (also called “150° C. 72-hour mass loss rate” hereinafter) of from 5% to 100%.

### 150° C. 72-Hour Mass Loss Rate

For the 150° C. 72-hour mass loss rate of the composition for well drilling, a sample is cut out to a size of 20 mm each in thickness, length, and width from a press-molded sheet formed from a composition for well drilling containing a reactive metal and a degradable resin composition that promotes degradation of the reactive metal, and the sample is immersed in 400 mL of 150° C. water (deionized water or the like) and then removed after 72 hours, and by comparing the mass of the sample measured after immersion to the mass of the sample measured in advance before immersion in 150° C. water (also called “initial mass” hereinafter), the loss rate (unit: %) of mass relative to the initial mass is calculated. Note that if the sample degrades and elutes out or loses its shape or dissipates while immersed in 150° C. water, the mass loss rate is taken as 100%.

Due to the fact that the composition for well drilling containing a reactive metal and a degradable resin composition that promotes degradation of the reactive metal has a 150° C. 72-hour mass loss rate of from 5% to 100%, the molded product degrades or disintegrates within several hours to several weeks in various well environments. Thus, it can contribute to reduced expense and shortening of processes for well drilling. Specifically, molded products for well drilling formed from a composition for well drilling containing a reactive metal and a degradable resin composition that promotes degradation of the reactive metal need to have various degradation time according to the environment such as various downhole temperatures and according to the processes carried out in that environment. Due to the fact that the composition for well drilling has a 150° C. 72-hour mass loss rate of more preferably from 50% to 100%, even more preferably from 80% to 100%, particularly preferably from 90% to 100%, and most preferably from 95% to 100%, it can have the property of exhibiting a function for a certain time while maintaining properties such as shape and strength required in the molded product for well drilling and then degrading in a desired short time (e.g., from several hours to several weeks), in various downhole temperature environments, such as 177° C., 163° C., 149° C., 121° C., 93° C., 80° C., or 66° C., as well as 25 to 40° C. The 150° C. 72-hour mass loss rate of the composition for well drilling containing a reactive metal and a degradable resin composition that promotes degradation of the reactive metal may be controlled by adjusting the composition of the degradable resin composition. Through this adjustment, the molded product for well drilling described above can be designed such that it exhibits a function for a prescribed time while maintaining its shape and properties without dissolving in water in a well environment at a temperature up to, for example, 80° C., and then, by contact with, for example, 149° C. water (contained in a well treatment fluid), its mass decreases substantially by 100% in several hours to several weeks, i.e., it substantially dissipates.

### Specific Examples of Composition for Well Drilling

### SPECIFIC EXAMPLE 1

As a degradable resin composition that promotes a degradation reaction of a reactive metal, 67 mass % of PGA (weight average molecular weight 210000, manufactured by Kureha Corporation), which qualifies as a degradable resin that generates acid upon degradation, and 33 mass % of a magnesium alloy (trade name: IN-Tallic (trade mark)) were mixed for 5 min at 230° C. using a φ30 mm single screw extruder with L/D=20 (2D25S, manufactured by Toyo Seiki Seisaku-sho, Ltd.), and a pellet-formed composition for well drilling containing a reactive metal and a degradable resin composition that promotes a degradation reaction of the reactive metal was obtained. When 3 g of the sample made from the obtained pellet-formed composition was put in 50 mL of water and left to stand at room temperature (25° C.), continuous generation of bubbles was seen, and after 3 days, nearly the entire amount of the sample had dissolved, although there was a slight amount of undissolved residue. From this fact it was understood that PGA generates acid upon degradation in room-temperature water, and by contacting the magnesium alloy present in the pellet-formed composition with said acid at a high concentration and at close proximity, said acid promotes degradation of the magnesium alloy.

### SPECIFIC EXAMPLE 2

A pellet-formed composition for well drilling was obtained by mixing 95 mass % of the PGA and 5 mass % of magnesium alloy described above for 5 min at 230° C. using the single screw extruder (2D25S, manufactured by Toyo Seiki Seisaku-sho, Ltd.) described above. Samples for bending modulus of elasticity measurement were prepared from the obtained composition using a melt molder. When a bending test was performed (n=10), the bending modulus of elasticity was 6560 MPa. Furthermore, the bending modulus of elasticity of a sample prepared from PGA alone was 6330 MPa. From this, it was understood that PGA, which qualifies as a degradable resin, can provide a composition for well drilling having improved mechanical properties when blended with a reactive metal.

### II. Molded Product for Well Drilling

According to a second aspect of the present invention, a molded product for well drilling formed from the composition for well drilling containing a reactive metal and a degradable resin composition that promotes degradation of the reactive metal of the various modes described above is provided. As is known, a molded product for well drilling is a molded product used when drilling a well provided for recovery of hydrocarbon resources such as petroleum and natural gas. Typical examples of molded products for well drilling include downhole tools used for well drilling and downhole tool members provided in said downhole tools, but are not limited thereto.

### 1. Downhole Tool and Downhole Tool Member

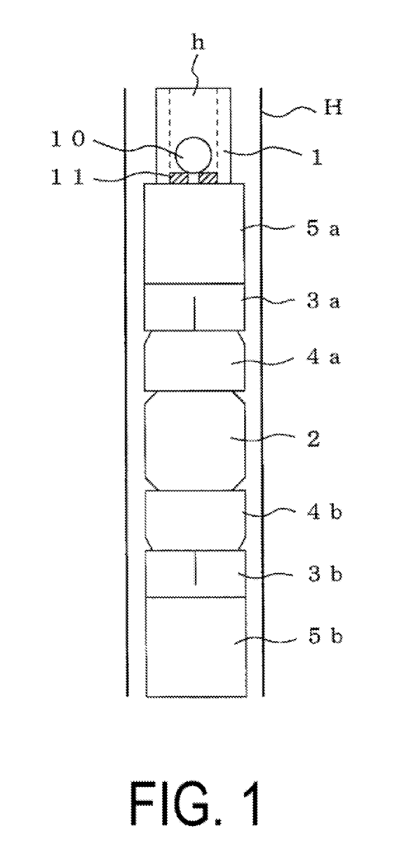

A downhole tool and downhole tool member which are typical molded products for well drilling will be described below in reference to FIG. 1, which is a schematic section view illustrating a specific example of a downhole tool which is a molded product for well drilling formed from the composition for well drilling of the present invention.

A typical structure of a plug (frac plug, bridge plug, or the like), which is a downhole tool, contains a mandrel 1, which is a downhole tool member extending in a direction that extends along the downhole (in many cases a hollow tubular body, but not limited thereto; approximate typical outer diameter from 30 to 200 mm, length from 250 to 2000 mm), and an annular rubber member 2, slips 3a and 3b, wedges 4a and 4b, and a pair of rings 5a and 5b and the like, which are downhole tool members placed circumferentially with separation in the axial direction of the mandrel 1 on the outer circumferential surface of the mandrel 1. The plug illustrated in the schematic section view of FIG. 1 also has a ball 10 and a substantially round annular ball seat 11 having a circular cavity with a smaller diameter than said ball 10, both of which are downhole tools, in the hollow part h of the mandrel 1. The case where fracturing (which is one well treatment operation) is performed using the above plug will be described below. Note that the structure of the plug which is a downhole tool is not limited to the structure described above.

The above pair of rings 5a and 5b are configured such that they can slide along the axial direction of the above mandrel 1 on the outer circumferential surface of the mandrel 1 and such that the spacing therebetween can be changed. In addition, they are configured such that a force along the axial direction of the mandrel 1 can be applied to the annular rubber member 2 and the combination of the slips 3a and 3b and the wedges 4a and 4b by coming into contact directly or indirectly with the end part along the axial direction of these members. The annular rubber member 2 expands in diameter in the direction orthogonal to the axial direction of the mandrel 1 as it is compressed and shortened in the axial direction of the mandrel 1, such that the outside comes into contact with the inside wall H of the downhole and the inside comes into contact with the outer circumferential surface of the mandrel 1, thereby plugging (sealing) the space between the plug and the downhole. Then, while fracturing is performed, the annular rubber member 2 can maintain a state of contact with the inside wall H of the downhole and the outer circumferential surface of the mandrel 1, thereby having the function of maintaining the seal between the plug and the downhole. In addition, as a result of the slips 3a and 3b sliding over the sloping upper surfaces of the wedges 4a and 4b when a force in the axial direction of the mandrel 1 is applied to the wedges 4a and 4b, the slips 3a and 3b can move outward in a direction orthogonal to the axial direction of the mandrel 1 and come into contact with the inside wall H of the downhole so as to fix the plug and the inside wall H of the downhole. Furthermore, although not illustrated, these downhole tool members may also have a ratchet mechanism such as a ring orthogonal to the axial direction of the mandrel 1, wherein a plurality of interlocking parts are formed, these parts permitting movement in one direction along the axial direction of the mandrel 1 of the member and restricting movement in the opposite direction.

Furthermore, each ball 10 and ball seat 11 provided in the hollow part h of the mandrel 1 can move along the axial direction of the mandrel 1 inside the hollow part h of the mandrel 1, and the flow direction of a fluid can be adjusted by means of the ball 10 coming into contact with or moving away from the circular gap of the ball seat 11.

According to an aspect of the present invention, if at least a portion of a downhole tool (member) as described above is a molded product formed from a composition for well drilling characterized by containing a reactive metal and a degradable resin composition that promotes degradation of the reactive metal, as excavation conditions have become harsh and diverse, it can reliably perform well treatment and can be easily removed under various well environment conditions, and thus can contribute to reducing the expense and shortening the processes of well drilling.

### 2. Shape, Composition, Properties, and the Like of Molded Product for Well Drilling

As long as it is a molded product for well drilling formed from a composition for well drilling containing a reactive metal and a degradable resin composition that promotes degradation of the reactive metal, the molded product for well drilling of the present invention formed from a composition for well drilling containing a reactive metal and a degradable resin composition that promotes degradation of the reactive metal may be selected in consideration of the specific application in well drilling, usage environment, and the like, without particular limitation on its shape as a molded product for well drilling or on its structure such as the mutual arrangement of the reactive metal and the degradable resin composition. Specifically, the shape of the molded product for well drilling may be granular, powdered, pellet-formed, or fibrous, or rod-shaped (round rod, square rod, heteromorphic cross section, and the like), tubular, plate-shaped (film-like or sheet-like), spherical, round pillar-shaped, square pillar-shaped, or the like, or a desired shape molded using a mold. Furthermore, it may be a single-layer molded product for well drilling, or a molded product for well drilling that is a laminate, an insert molded product, or an outsert molded product. As the size of the molded product for well drilling, the maximum thickness or maximum diameter of the molded product for well drilling may be typically from 5 to 500 mm, often from 10 to 400 mm, and nearly always from 20 to 300 mm. In a molded product for well drilling having a granular shape or the like, the diameter may be from 0.2 to 10 mm, and in many cases from approximately 0.5 to 5 mm. These molded products for well drilling may be manufactured by known methods for molding molded products having the respective shapes and the like.

### Molded Product for Well Drilling Wherein Reactive Metal and Degradable Resin Composition are Both in Granular Form

The molded product for well drilling of the present invention may be a molded product for well drilling in which the reactive metal and the degradable resin composition are both in granular form. That is, a molded product for well drilling that is an aggregate of particles may be obtained by sintering, fusing, or adhering granules to each other and molding them into a prescribed shape by a method similar to so-called powder metallurgy, wherein the granules are granules formed from the reactive metal and granules formed from the degradable resin composition (these granules may be prepared by a known method).

With a molded product for well drilling in which both the reactive metal and the degradable resin composition are granular, due to the fact that the degradable resin that generates acid upon degradation contained in the degradable resin composition degrades by means of, for example, the molded product being contacted by aqueous fluid in a prescribed well environment, the molded product for well drilling loses its initial shape and becomes a simple aggregate of reactive metal granules, and the produced acid can contact the reactive metal granules. Thus, a degradation reaction of the reactive metal is promoted, and the molded product for well drilling decreases in volume and can dissipate, and also loses its strength as a molded product for well drilling, and thus can be easily removed. With a molded product for well drilling in which both the reactive metal and the degradable resin composition are granular, due to the fact that the degradable resin (water-soluble resin, degradable rubber, or the like) contained in the degradable resin composition elutes or absorbs water to degrade and lose its shape by means of, for example, the molded product for well drilling being contacted by an aqueous fluid in a prescribed well environment, the molded product for well drilling loses its initial shape and becomes a simple aggregate of reactive metal granules, and becomes such that an inorganic material or organic material (degradation trigger) that promotes degradation of the reactive metal, such as potassium chloride, can contact the reactive metal granules. Thus, a degradation reaction of the reactive metal is promoted, and the molded product for well drilling decreases in volume and can dissipate, and also loses its strength as a molded product for well drilling, and thus can be easily removed.

Molded product for well drilling wherein one of the components, being the reactive metal or the degradable resin composition, is dispersed in the other component The molded product for well drilling of the present invention may be a molded product for well drilling in which one of the components, being the reactive metal or the degradable resin composition, is dispersed in the other component. Specifically, it is a molded product for well drilling in which a reactive metal is continuously or discontinuously dispersed in a matrix of a degradable resin composition, or a molded product for well drilling in which a degradable resin composition is continuously or discontinuously dispersed in a matrix of a reactive metal. This molded product for well drilling may be prepared in a desired shape by a known molding method such as melt molding (extrusion molding, injection molding, centrifugal molding, or the like), compression molding, solvent casting, or the like.

With a molded product for well drilling in which one of the components, being either the reactive metal or the degradable resin composition, is dispersed in the other component, in a similar manner described above, the acid produced by degradation of the degradable resin composition or an inorganic material or organic material (degradation trigger) that promotes degradation of the reactive metal can contact the reactive metal by means of, for example, the molded product for well drilling being contacted by an aqueous fluid in a prescribed well environment. Thus, a degradation reaction of the reactive metal is promoted, and the molded product for well drilling decreases in volume and can dissipate, and also loses its strength as a molded product for well drilling, and thus can be easily removed.

### Molded Product for Well Drilling Containing a Layer Containing Both Reactive Metal and Degradable Resin Composition

The molded product for well drilling of the present invention may be a molded product for well drilling containing both the reactive metal and the degradable resin composition. Specifically, this molded product for well drilling is a molded product for well drilling having a broadly defined laminate structure containing one or more layer(s) containing both the reactive metal and the degradable resin composition. Said laminate structure and shape of this molded product for well drilling having a broadly defined laminate structure is not particularly limited, and includes narrowly defined laminates (for example, sheet-like laminates, tubular laminates, and the like), laminates having a surface coated structure (core-coating structure, core-sheath structure, and the like), as well as insert molded products, outsert molded products, and the like. The surface coated structure herein may be a discontinuous surface coated structure, such as a molded product for well drilling in which, on a layer containing the reactive metal or a sheet-like layer made from one component that is the degradable resin composition, a layer is formed by arranging the other component in granular form.

For the molded product for well drilling having the laminate structure described above, a molded product having the desired shape and layer structure may be prepared by a known production method of lamination molded products and the like (including insert molding or outsert molding). It may be a molded product for well drilling having one layer containing both the reactive metal and the degradable resin composition, or it may be a molded product for well drilling having a plurality of layers, and the composition of the plurality of layers may be the same or different. In a molded product for well drilling having a laminate structure, a layer other than the layer containing both a reactive metal and a degradable resin composition may be a layer containing a reactive metal or layers containing a degradable resin composition, or a layer that is neither a layer containing a reactive metal nor a layer containing a degradable resin composition.

For a molded product for well drilling having a layer containing a reactive metal and a layer containing a degradable resin composition, in a similar manner described above, an acid produced by degradation of the degradable resin composition or an inorganic material or organic material that promotes degradation of the reactive metal (degradation trigger) contacts the reactive metal by means of, for example, the molded product for well drilling being contacted by aqueous fluid in a prescribed well environment. As a result, a degradation reaction of the reactive metal is promoted, and the molded product for well drilling having a laminate structure decreases in volume and can dissipate, and also loses its strength as a molded product for well drilling, and thus can be easily removed. Furthermore, by adjusting the composition, thickness, and shape of the layer containing both the reactive metal and the degradable resin composition, the strength, degradability, and the like of the molded product for well drilling having a laminate structure can be adjusted.

### Molded Product for Well Drilling Containing a Plurality of Layers of Different Compositions

If desired, by using a molded product for well drilling having a plurality of layers of different compositions and containing both reactive metal and degradable resin composition as the molded product for well drilling having a layer containing both the reactive metal and the degradable resin composition, a so-called gradient material can be obtained, thereby making it possible to adjust the strength, degradability, and the like of the molded product for well drilling more finely, so as to be compatible with various well environments.

### Fully Degradable Molded Product for Well Drilling

The molded product for well drilling according to an aspect of the present invention, formed from a composition for well drilling containing a reactive metal and a degradable resin composition that promotes a degradation reaction of the reactive metal, e.g., a downhole tool, includes a downhole tool member (molded product for well drilling) having one or a plurality of layers containing both the reactive metal and the degradable resin composition. Such a molded product for well drilling, as desired, may include a downhole tool member containing the reactive metal or the degradable resin composition or a degradable rubber member containing a degradable rubber (for example, which may be used as all or part of the annular rubber member which is a downhole tool member). As a result, all of the downhole tools may be completely degradable downhole tools (molded products for well drilling) that can degrade in a well environment. In particular, an acid that can promote degradation of the reactive metal or a degradation trigger such as potassium chloride may be supplied to the same or another downhole tool member provided in the downhole tool (molded product for well drilling). Thus, it can contribute to reducing the expense and shortening the processes of well drilling because there is no need for a special additional operation such as injection of acid into the well conventionally employed to degrade and remove downhole tool members containing reactive metals.

### 3. Specific Examples of Molded Product for Well Drilling and the Like

An example of the molded product for well drilling according to an aspect of the present invention formed from a composition for well drilling characterized by containing a reactive metal and a degradable resin composition that promotes degradation of the reactive metal is a molded product for well drilling which is a downhole tool (member) as described above, but from the perspective of being capable of reliable well treatment and being easily removable, more specific examples include molded products for well drilling which are plugs, molded products for well drilling which are balls, molded products for well drilling which are ball seats, and molded products for well drilling which are in granular form, pellet form, fiber form, or film form, and the like. As desired, examples of molded products for well drilling, particularly those in granular form, pellet form, fiber form, or film form, include molded products for well drilling which are proppants and molded products for well drilling which are temporary plugging agents.

### Well Treatment Fluid

Another aspect of the present invention provides a well treatment fluid containing a molded products for well drilling, for example, a drilling fluid, cementing fluid, perforating fluid, fracturing fluid, completion fluid, or the like, in which the molded products for well drilling, which is in granular form, pellet form, fiber form, or film form, the molded product for well drilling which is a proppant, or the molded product for well drilling which is a temporary plugging agent, as described above, is dispersed at a required content, together with other required components.

The molded product for well drilling according to an aspect of the present invention is a molded product for well drilling formed from a composition for well drilling characterized by containing a reactive metal and a degradable resin composition that promotes degradation of the reactive metal according to various aspects of the present invention as described above. Thus, the molded product for well drilling according to an aspect of the present invention can have the property of exhibiting a required function for a certain time while maintaining properties such as shape and strength required in the molded product for well drilling and then degrading in a short time, in various downhole temperature environments, such as 177° C., 163° C., 149° C., 121° C., 93° C., 80° C., or 66° C., as well as 25 to 40° C., as excavation conditions have become harsh and diverse. Furthermore, as for a molded product for well drilling which is a proppant, there is a recent demand that such a molded product can be removed, for example after well completion, to expand flow path volume and increase the produced quantity of the hydrocarbon resource. In response to such a demand, a molded product for well drilling which is a proppant can have the property of degrading in a short time in various downhole temperature environments such as 177° C., 163° C., 149° C., 121° C., 93° C., 80° C., or 66° C., as well as 25 to 40° C.

### 4. Method for Producing Molded Product for Well Drilling

The molded product for well drilling of the present invention may be manufactured by applying known molding methods of molded products conventionally employed for manufacturing various molded products from a polymer as described above.

Typically, according to an aspect of the present invention, a molded product molded by melt molding is provided. As the melt molding method, general-purpose melt molding methods may be employed, such as injection molding, compression molding, centrifugal molding, extrusion molding (injection molding, blow molding, and the like using a T die, rod die or annular die may be employed, as well as solidification- and extrusion-molding). Additionally, a molded product having the desired shape (shapes such as ball-shaped, heteromorphic cross section, and the like) can be manufactured by performing machining such as cutting or perforation using a molded product obtained by these melt molding methods as a premolded product (shapes such as rod-shaped, hollow-shaped, or plate-shaped may be used). Particularly preferably, a molded product may be formed by solidification- and extrusion-molding and machining. Thus, according to an aspect of the present invention, a molded product formed by any of injection molding, compression molding, centrifugal molding, extrusion molding, or solidification- and extrusion-molding and machining is provided.

Alternatively, the molded product for well drilling according to an aspect of the present invention may be manufactured by aggregating granules, similar to powder metallurgy, as described above. Similarly, the molded product for well drilling according to an aspect of the present invention, for example, a sheet-like molded product, may be manufactured by a solvent-cast method. And a molded product of a desired structure may be manufactured by lamination molding, insert molding, or outsert molding.

### III. Method for Well Drilling

According to yet another aspect of the present invention, a method for well drilling using the molded product for well drilling according to an aspect of the present invention previously described is provided, and furthermore, a method for well drilling including performing well treatment such as fracturing using the above molded product for well drilling, and then degrading and dissipating the reactive metal using the above degradable resin composition, is provided. In particular, provided is a method for well drilling in which well treatment such as fracturing is performed using the downhole tool described above, after which the degradable resin contained in the degradable resin composition described above degrades, and the reactive metal is degraded and dissipated by the produced acid or the inorganic material or organic material that promotes degradation of the released reactive metal. Also provided is a method for well drilling in which well treatment is performed using the downhole tool further having a degradable rubber member described above, after which the degradable resin contained in the above degradable resin composition degrades, and the reactive metal is degraded and dissipated by the produced acid or the inorganic material or organic material that promotes degradation of the released reactive metal, and in parallel, as desired, the degradable rubber member also disintegrates or dissipates due to degradation. Furthermore, the present invention provides a method for well treatment using the molded product for well drilling described above by which, as excavation conditions have become harsh and diverse such as increased depth, well treatment can be reliably performed and the molded product for well drilling such as a downhole tool (member) can be easily removed, and it can thus contribute to reducing the expense and shortening the processes of well drilling.

For example, the method for well drilling according to an aspect of the present invention is a method for performing well treatment such as perforation or fracturing in a downhole using a molded product for well drilling which is a downhole tool (member), and particularly a molded product for well drilling which is a plug (frac plug, bridge plug, and the like). Additionally, the method for well drilling according to an aspect of the present invention is a method for performing well treatment such as perforation or fracturing in a downhole using a molded product for well drilling which is a combination of a ball and a ball seat. Furthermore, the method for well drilling according to an aspect of the present invention is a method for performing fracturing using a fracturing fluid containing a molded product for well drilling which is a proppant.

More specifically, a method for well drilling using a downhole tool having a mandrel (which is a downhole tool member) which is the molded product for well drilling according to an aspect of the present invention will be described. As described above, the annular rubber member expands in the direction orthogonal to the axial direction of a mandrel, which is the molded product for well drilling according to an aspect of the present invention, as it is compressed in the axial direction of the mandrel. Thus, the outer circumferential surface of the mandrel comes into contact with the inside wall of the downhole to plug (seal) the space between the plug and the downhole. Then, while fracturing is performed, the annular rubber member maintains a state of contact between the inside wall of the downhole and the outer circumferential surface of the mandrel, thereby having the function of maintaining the seal between the plug and the downhole. The molded product for well drilling according to an aspect of the present invention or the mandrel which is made from the molded product can continue to maintain, for a prescribed period, the strength to withstand the large load arising from the high pressure of the fracturing fluid. Then, after fracturing is completed, the mandrel which is the molded product for well drilling according to an aspect of the present invention degrades in a desired short time such as several hours to several weeks in various downhole temperature environments, such as 177° C., 163° C., 149° C., 121° C., 93° C., 80° C., or 66° C., as well as 25 to 40° C., and the said mandrel decreases in volume or loses its shape, and the seal between the plug and the downhole is eliminated. Furthermore, the mandrel loses its initial shape, and the downhole tool (specifically the plug) having the mandrel as a downhole tool member loses its initial shape.

Note that if the well temperature is low and degradation of the downhole tool (member), which is the molded product for well drilling according to an aspect of the present invention, does not readily proceed at the desired speed, a fluid of a higher temperature can be supplied surrounding the downhole tool, for example. Conversely, in a downhole environment in which the well temperature is high and degradation of the downhole tool (member) which is the molded product for well drilling according to an aspect of the present invention ends up starting and proceeding before the desired time has elapsed, a method for well treatment may be employed so as to reduce the temperature around the downhole tool (member) by injecting a fluid from above ground (cooldown injection). Because it is unnecessary to recover or destroy the downhole tool (member) which is the molded product for well drilling, the method for well drilling of the present invention can contribute to reducing the expense and shortening the processes of well drilling.

Similarly, in a method for well drilling using a combination of a ball and ball seat which are molded products for well drilling according to an aspect of the present invention, the combination of the ball and ball seat can continue to maintain, for a prescribed period, the seal strength to withstand the large load arising from the high pressure of the fracturing fluid. Then, after fracturing is completed, the combination of the ball and ball seat which are the molded products for well drilling according to an aspect of the present invention degrades in a desired short time such as several hours to several weeks in various downhole temperature environments, such as 177° C., 163° C., 149° C., 121° C., 93° C., 80° C., or 66° C., as well as 25 to 40° C., for example, and the diameter of the ball becomes smaller than its initial diameter, and/or the thickness of the ball seat decreases, and the seal between the plug and the downhole due to the ball and ball seat is eliminated. Furthermore, the ball that shrunk in diameter can pass through the round cavity of the ball seat.

Additionally, in a method for well drilling for performing fracturing using a fracturing fluid containing a proppant, which is the molded product for well drilling according to an aspect of the present invention, for example, after the well is completed or the like, the proppant can be removed when desired by degrading it with the objective of removing the proppant and expanding the flow path of the hydrocarbon resource, in a desired short time such as several hours to several weeks in various downhole temperature environments, such as 177° C., 163° C., 149° C., 121° C., 93° C., 80° C., or 66° C., as well as 25 to 40° C., and this can contribute to increasing the produced quantity of the hydrocarbon resource.

### VII. Summary

According to a first aspect of the present invention, (1) a composition for well drilling containing a reactive metal and a degradable resin composition that promotes degradation of the reactive metal is provided.

Additionally, according to the present invention, as specific modes of the invention pertaining to the composition for well drilling of the above (1), the compositions for well drilling of the below (2) to (13) are provided.

(2) The composition for well drilling according to the above (1), wherein the degradable resin composition comprises a degradable resin generating acid upon degradation.

(3) The composition for well drilling according to the above (1) or (2), wherein the degradable resin composition comprises an aliphatic polyester.

(4) The composition for well drilling according to the above (3), wherein the aliphatic polyester is one or more type(s) selected from the group consisting of polyglycolic acids, polylactic acids, and glycolic acid-lactic acid copolymers.

(5) The composition for well drilling according to any one of the above (1) to (4), wherein the degradable resin composition comprises a degradable resin and an inorganic material or an organic material promoting degradation of the reactive metal.

(6) The composition for well drilling according to the above (5), wherein the inorganic material promoting degradation of the reactive metal is an inorganic salt.

(7) The composition for well drilling according to the above (6), wherein the inorganic salt comprises either potassium chloride or sodium chloride.

(8) The composition for well drilling according to any one of the above (5) to (7), wherein the degradable resin comprises a water-soluble resin.

(9) The composition for well drilling according to the above (8), wherein the water-soluble resin comprises a polyvinyl alcohol-based polymer.

(10) The composition for well drilling according to any one of the above (5) to (9), wherein the degradable resin comprises a degradable rubber.

(11) The composition for well drilling according to any one the above (1) to (10), wherein the degradable resin composition comprises a filler.

(12) The composition for well drilling according to any one of the above (1) to (11), wherein the reactive metal comprises one or more type(s) selected from the group consisting of magnesium, aluminum, and calcium.

(13) The composition for well drilling according to any one of the above (1) to (12), wherein a loss rate of mass after immersion for 72 hours in 150° C. water relative to a mass before immersion is from 5% to 100%.

According to a second aspect of the present invention, (14) a molded product for well drilling formed from the composition for well drilling described in any one of the above (1) to (13) is provided.

Additionally, according to the present invention, as specific modes of the invention pertaining to the molded product for well drilling of the above (14), the molded products for well drilling of the below (15) to (25) are provided.

(15) The molded product for well drilling according to the above (14), wherein the reactive metal and the degradable resin composition are both in granular form.

(16) The molded product for well drilling according to the above (14) or (15), wherein one of the components, being the reactive metal or the degradable resin composition, is dispersed in the other component.

(17) The molded product for well drilling according to any one of the above (14) to (16), wherein the composition comprises a layer comprising both the reactive metal and the degradable resin composition.

(18) The molded product for well drilling according to any one of the above (14) to (17), wherein the composition comprises a plurality of layers of different compositions, the layers comprising both the reactive metal and the degradable resin composition.

(19) The molded product for well drilling according to any one of the above (14) to (18), wherein the product is a downhole tool or a downhole tool member.

(20) The molded product for well drilling according to any one of the above (14) to (19), wherein the product is a plug.

(21) The molded product for well drilling according to any one of the above (14) to (19), wherein the product is a ball.

(22) The molded product for well drilling according to any one of the above (14) to (19), wherein the product is a ball seat.

(23) The molded product for well drilling according to any one of the above (14) to (19), wherein the product is in granular form, pellet form, fiber form, or film form.

(24) The molded product for well drilling according to any one of the above (14) to (19), wherein the product is a proppant.

(25) The molded product for well drilling according to any one of the above (14) to (19), wherein the product is a temporary plugging agent.

Additionally, according to another aspect of the present invention, (26) a well treatment fluid comprising the molded product for well drilling described in any one of the above (23) to (25) is provided. According to yet another aspect of the present invention, (27) a method for well drilling, the method using the molded product for well drilling described in any one of the above (14) to (25), and (28) a method for well drilling comprising performing well treatment using the molded product for well drilling described in any one of the above (14) to (25), and then degrading and dissipating the reactive metal using the degradable resin composition, are provided.

### INDUSTRIAL APPLICABILITY

The present invention has high industrial applicability because it can provide a composition for well drilling which, due to being a composition for well drilling characterized by comprising a reactive metal and a degradable resin composition promoting degradation of the reactive metal, as excavation conditions have become harsh and diverse, is degradable in certain environments and has excellent strength, and is suitable for forming a molded product for well drilling such as a downhole tool (member) or the like that can reliably perform well treatment, can be easily removed, and can contribute to reducing the expense and shortening the processes of well drilling.

Furthermore, the present invention has high industrial applicability because it can provide a molded product for well drilling and a well treatment fluid which, due to being a molded product for well drilling such as a downhole tool or downhole tool member formed form the above composition for well drilling, as excavation conditions have become harsh and diverse, can reliably perform well treatment, can be easily removed under diverse well environment conditions, and can contribute to reducing the expense and shortening the processes of well drilling.

Furthermore, the present invention has high industrial applicability because it can provide a method for well treatment using the above molded product for well drilling which, as excavation conditions have become harsh and diverse, can reliably perform well treatment, can be easily removed, and can contribute to reducing the expense and shortening the processes of well drilling.

### REFERENCE SIGNS LIST

1 Mandrel

2 Annular rubber member (degradable rubber member)

3a, 3b Slip

4a, 4b Wedge

5a, 5b (Pair of) Ring

10 Ball (ball sealer)

11 Ball seat

H Inside wall of downhole

h Hollow part of mandrel

1. A composition for well drilling comprising a reactive metal and a degradable resin composition promoting degradation of the reactive metal.

2. The composition for well drilling according to claim 1, wherein the degradable resin composition comprises a degradable resin generating acid upon degradation.

3. The composition for well drilling according to claim 1, wherein the degradable resin composition comprises an aliphatic polyester.

4. The composition for well drilling according to claim 3, wherein the aliphatic polyester is one or more selected from the group consisting of polyglycolic acid, polylactic acid, and glycolic acid-lactic acid copolymer.

5. The composition for well drilling according to claim 1, wherein the degradable resin composition comprises a degradable resin and an inorganic material or an organic material promoting degradation of the reactive metal.

6. The composition for well drilling according to claim 5, wherein the inorganic material promoting degradation of the reactive metal is an inorganic salt.

7. (canceled)

8. The composition for well drilling according to claim 5, wherein the degradable resin comprises a water-soluble resin.

9. (canceled)

10. (canceled)

11. The composition for well drilling according to claim 1, wherein the degradable resin composition comprises a filler.

12. The composition for well drilling according to claim 1, wherein the reactive metal comprises one or more selected from the group consisting of magnesium, aluminum, and calcium.

13. (canceled)

14. A molded product for well drilling formed from the composition for well drilling described in claim 1.

15. (canceled)

16. The molded product for well drilling according to claim 14, wherein one of the components, being the reactive metal or the degradable resin composition, is dispersed in the other component.

17. The molded product for well drilling according to claim 14, wherein the product comprises a layer comprising both the reactive metal and the degradable resin composition.

18. The molded product for well drilling according to claim 14, wherein the product comprises a plurality of layers of different compositions, the layers comprising both the reactive metal and the degradable resin composition.

19. The molded product for well drilling according to claim 14, wherein the product is a downhole tool or a downhole tool member.

20. (canceled)

21. (canceled)

22. (canceled)

23. The molded product for well drilling according to claim 14, wherein the product is in granular form, pellet form, fiber form, or film form.

24. The molded product for well drilling according to claim 14, wherein the product is a proppant.

25. The molded product for well drilling according to claim 14, wherein the product is a temporary plugging agent.

26. A well treatment fluid comprising the molded product for well drilling described in claim 23.

27. A method for well drilling, the method using the molded product for well drilling described in claim 14.

28. (canceled)
